(19) United States
(12) Patent Application Publication
(10) Pub. No.: US 2022/0402136 A1
(43) Pub. Date: Dec. 22, 2022

(54) System and Method for Robotic Evaluation

(71) Applicants: Biao Zhang, West Hartford, CT (US); ABB Schweiz AG, Baden (CH)

(72) Inventors: Biao Zhang, West Hartford, CT (US); Saumya Sharma, Hartford, CT (US); Yixin Liu, Houghton, MI (US); Jianjun Wang, West Hartford, CT (US); Will Eakins, Coventry, CT (US); Andrew Salm, West Hartford, CT (US); Yun Hsuan Su, Seattle, WA (US); Jorge Vidal-Ribas, Esplugues de Llobregat (ES); Ramon Casanelles, Sant Cugat del Vellès (ES); Jordi Artigas, Barcelona (ES)

(73) Assignee: ABB Schweiz AG, Baden (CH)

(21) Appl. No.: 17/772,365

(22) PCT Filed: Oct. 29, 2019
(86) PCT No.: PCT/US2019/058529

§ 371 Date: Apr. 27, 2022

(51) Int. Cl. B25J 9/16; B25J 13/08

(52) U.S. Cl. CPC B25J 9/1676; B25J 13/085; B25J 9/1697

(57) ABSTRACT

A system and method for determining performance of a robot. In one form the robot is constructed as you assembling automotive workpieces onto an automobile assembly. In one form the robot accomplishes the task of assembling an automotive workpiece onto the automotive assembly by using vision feedback and force feedback. The vision feedback can use any number of features perform its function. Such features can include an artificial feature such as but not limited to a QR code, as well as a natural feature such as a portion of the workpiece or automotive assembly. In one embodiment the robot is capable of detecting a collision event and assessing the severity of the collision event. In another embodiment the robot is capable of evaluating its performance by attracting a performance metric against a performance threshold, and comparing a sensor fusion output with a sensor fusion output reference.

### FIELD OF INVENTION

The present invention relates to robotic controllers, and more particularly, to a system and method for evaluating robot performance to determine appropriate control actions.

### BACKGROUND

A variety of operations can be performed during the final trim and assembly (FTA) stage of automotive assembly, including, for example, door assembly, cockpit assembly, and seat assembly, among other types of assemblies. Yet, for a variety of reasons, only a relatively small number of FTA tasks are typically automated. For example, often during the FTA stage, while an operator is performing an FTA operation, the vehicle(s) undergoing FTA is/are being transported on a line(s) that is/are moving the vehicle(s) in a relatively continuous stop and go manner. Yet such continuous stop and go motions of the vehicle(s) can cause or create certain irregularities with respect to at least the movement and/or position of the vehicle(s), and/or the portions of the vehicle(s) that are involved in the FTA. Moreover, such stop and go motion can cause the vehicle to be subjected to movement irregularities, vibrations, and balancing issues during FTA, which can prevent, or be adverse to, the ability to accurately model or predict the location of a particular part, portion, or area of the vehicle that directly involved in the FTA. Further, such movement irregularities can prevent the FTA from having a consistent degree of repeatability in terms of the movement and/or positioning of each vehicle, or its associated component, as each subsequent vehicle and/or component passes along the same area of the assembly line. Accordingly, such variances and concerns regarding repeatability can often preclude the use of traditional teach and repeat position based robot motion control in FTA operations.

Accordingly, although various robot control systems are available currently in the marketplace, further improvements are possible to provide a system and means to calibrate the robot control system to accommodate such movement irregularities.

### BRIEF SUMMARY

One embodiment of the present invention is a unique robot controller. Other embodiments include apparatuses, systems, devices, hardware, methods, and combinations for assessing robot performance. Further embodiments, forms, features, aspects, benefits, and advantages of the present application shall become apparent from the description and figures provided herewith.

These and other aspects of the present invention will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates a schematic representation of at least a portion of an exemplary robotic system according to an illustrated embodiment of the present application.

FIG. 2 illustrates a schematic representation of an exemplary robot station through which vehicles are moved through by an automated or automatic guided vehicle (AGV), and which includes a robot that is mounted to a robot base that is moveable along, or by, a track.

FIG. 3 illustrates an exemplary first or artificial calibration feature that can be used in connection with at least initial calibration of robotic sensors that can be involved in sensor fusion guided robotic movement.

FIG. 4 illustrates an exemplary second or nature calibration feature that can be used in connection with refining the calibration of at least pre-calibrated sensors that can be involved in sensor fusion guided robotic movement.

FIG. 5 illustrates an exemplary process for calibrating one or more sensors of a sensor fusion guided robot.

FIG. 6 illustrates an exemplary process for assessing a collision event.

FIG. 7 illustrates an exemplary process for evaluating robot performance.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

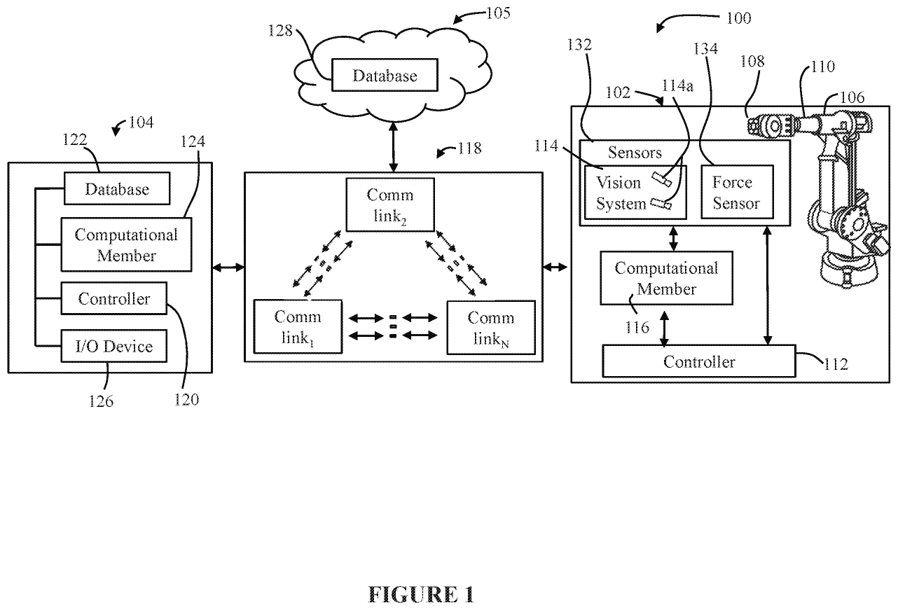

FIG. 1 illustrates at least a portion of an exemplary robotic system 100 that includes at least one robot station 102 that is communicatively coupled to at least one management system 104, such as, for example, via a communication network or link 118. The management system 104 can be local or remote relative to the robot station 102. Further, according to certain embodiments, the robot station 102 can also include, or be in operable communication with, one or more supplemental database systems 105 via the communication network or link 118. The supplemental database system(s) 105 can have a variety of different configurations. For example, according to the illustrated embodiment, the supplemental database system(s) 105 can be, but is not limited to, a cloud based database.

According to certain embodiments, the robot station 102 includes one or more robots 106 having one or more degrees of freedom. For example, according to certain embodiments, the robot 106 can have, for example, six degrees of freedom. According to certain embodiments, an end effector 108 can be coupled or mounted to the robot 106. The end effector 108 can be a tool, part, and/or component that is mounted to a wrist or arm 110 of the robot 106. Further, at least portions of the wrist or arm 110 and/or the end effector 108 can be moveable relative to other portions of the robot 106 via operation of the robot 106 and/or the end effector 108, such for, example, by an operator of the management system 104 and/or by programming that is executed to operate the robot 106.

The robot 106 can be operative to position and/or orient the end effector 108 at locations within the reach of a work envelope or workspace of the robot 106, which can accommodate the robot 106 in utilizing the end effector 108 to perform work, including, for example, grasp and hold one or more components, parts, packages, apparatuses, assemblies, or products, among other items (collectively referred to herein as “components”). A variety of different types of end effectors 108 can be utilized by the robot 106, including, for example, a tool that can grab, grasp, or otherwise selectively hold and release a component that is utilized in a final trim and assembly (FTA) operation during assembly of a vehicle, among other types of operations.

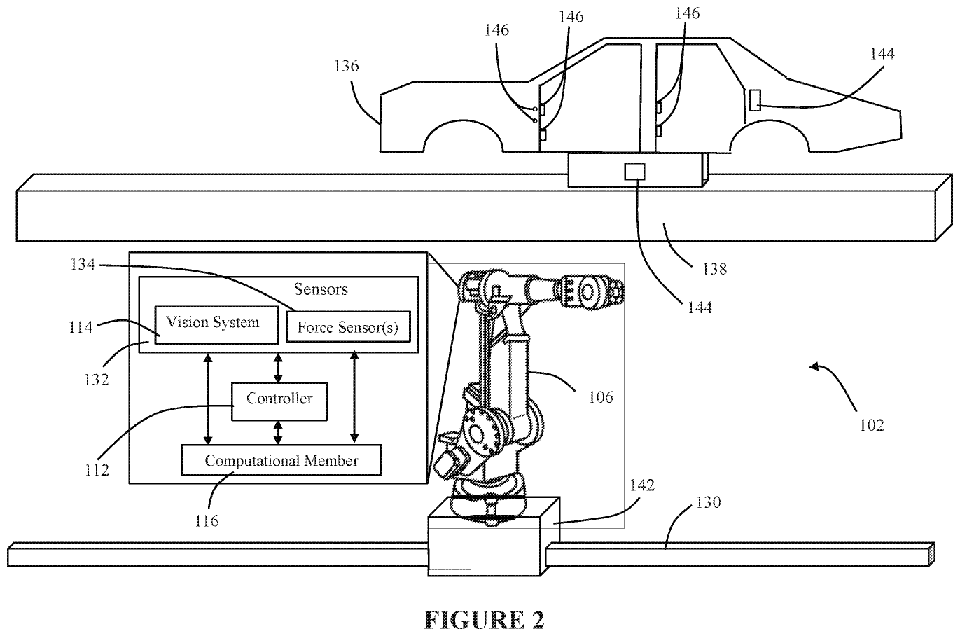

The robot 106 can include, or be electrically coupled to, one or more robotic controllers 112. For example, according to certain embodiments, the robot 106 can include and/or be electrically coupled to one or more controllers 112 that may, or may not, be discrete processing units, such as, for example, a single controller or any number of controllers. The controller 112 can be configured to provide a variety of functions, including, for example, be utilized in the selective delivery of electrical power to the robot 106, control of the movement and/or operations of the robot 106, and/or control the operation of other equipment that is mounted to the robot 106, including, for example, the end effector 108, and/or the operation of equipment not mounted to the robot 106 but which are an integral to the operation of the robot 106 and/or to equipment that is associated with the operation and/or movement of the robot 106. Moreover, according to certain embodiments, the controller 112 can be configured to dynamically control the movement of both the robot 106 itself, as well as the movement of other devices to which the robot 106 is mounted or coupled, including, for example, among other devices, movement of the robot 106 along, or, alternatively, by, a track 130 or mobile platform such as AGV to which the robot 106 is mounted via a robot base 142, as shown in FIG. 2.

The controller 112 can take a variety of different forms, and can be configured to execute program instructions to perform tasks associated with operating robot 106, including to operate the robot 106 to perform various functions, such as, for example, but not limited to, the tasks described herein, among other tasks. In one form, the controller(s) 112 is/are microprocessor based and the program instructions are in the form of software stored in one or more memories. Alternatively, one or more of the controllers 112 and the program instructions executed thereby can be in the form of any combination of software, firmware and hardware, including state machines, and can reflect the output of discreet devices and/or integrated circuits, which may be co-located at a particular location or distributed across more than one location, including any digital and/or analog devices configured to achieve the same or similar results as a processor-based controller executing software or firmware based instructions. Operations, instructions, and/or commands determined and/or transmitted from the controller 112 can be based on one or more models stored in non-transient computer readable media in a controller 112, other computer, and/or memory that is accessible or in electrical communication with the controller 112.

According to the illustrated embodiment, the controller 112 includes a data interface that can accept motion commands and provide actual motion data. For example, according to certain embodiments, the controller 112 can be communicatively coupled to a pendant, such as, for example, a teach pendant, that can be used to control at least certain operations of the robot 106 and/or the end effector 108.

The robot station 102 and/or the robot 106 can also include one or more sensors 132. The sensors 132 can include a variety of different types of sensors and/or combinations of different types of sensors, including, but not limited to, a vision system 114, force sensors 134, motion sensors, acceleration sensors, and/or depth sensors, among other types of sensors. Further, information provided by at least some of these sensors 132 can be integrated, including, for example, via use of algorithms, such that operations and/or movement, among other tasks, by the robot 106 can at least be guided via sensor fusion. Thus, as shown by at least FIGS. 1 and 2, information provided by the one or more sensors 132, such as, for example, a vision system 114 and force sensors 134, among other sensors 132, can be processed by a controller 120 and/or a computational member 124 of a management system 104 such that the information provided by the different sensors 132 can be combined or integrated in a manner that can reduce the degree of uncertainty in the movement and/or performance of tasks by the robot 106.

According to the illustrated embodiment, the vision system 114 can comprise one or more vision devices 114a that can be used in connection with observing at least portions of the robot station 102, including, but not limited to, observing, parts, component, and/or vehicles, among other devices or components that can be positioned in, or are moving through or by at least a portion of, the robot station 102. For example, according to certain embodiments, the vision system 114 can extract information for a various types of visual features that are positioned or placed in the robot station 102, such, for example, on a vehicle and/or on automated guided vehicle (AGV) that is moving the vehicle through the robot station 102, among other locations, and use such information, among other information, to at least assist in guiding the movement of the robot 106, movement of the robot 106 along a track 130 or mobile platform such as AGV (FIG. 2) in the robot station 102, and/or movement of an end effector 108. Further, according to certain embodiments, the vision system 114 can be configured to attain and/or provide information regarding at a position, location, and/or orientation of one or more first or artificial calibration features and/or second or nature calibration features that can be used to calibrate the sensors 132 of the robot 106, as discussed below.

According to certain embodiments, the vision system 114 can have data processing capabilities that can process data or information obtained from the vision devices 114a that can be communicated to the controller 112. Alternatively, according to certain embodiments, the vision system 114 may not have data processing capabilities. Instead, according to certain embodiments, the vision system 114 can be electrically coupled to a computational member 116 of the robot station 102 that is adapted to process data or information outputted from the vision system 114. Additionally, according to certain embodiments, the vision system 114 can be operably coupled to a communication network or link 118, such that information outputted by the vision system 114 can be processed by a controller 120 and/or a computational member 124 of a management system 104, as discussed below.

Examples of vision devices 114a of the vision system 114 can include, but are not limited to, one or more imaging capturing devices, such as, for example, one or more two-dimensional, three-dimensional, and/or RGB cameras that can be mounted within the robot station 102, including, for example, mounted generally above the working area of the robot 106, mounted to the robot 106, and/or on the end effector 108 of the robot 106, among other locations. Further, according to certain embodiments, the vision system 114 can be a position based or image based vision system. Additionally, according to certain embodiments, the vision system 114 can utilize kinematic control or dynamic control.

According to the illustrated embodiment, in addition to the vision system 114, the sensors 132 also include one or more force sensors 134. The force sensors 134 can, for example, be configured to sense contact force(s) during the assembly process, such as, for example, a contact force between the robot 106, the end effector 108, and/or a component being held by the robot 106 with the vehicle 136 and/or other component or structure within the robot station 102. Such information from the force sensor(s) 134 can be combined or integrated with information provided by the vision system 114 such that movement of the robot 106 during assembly of the vehicle 136 is guided at least in part by sensor fusion.

According to the exemplary embodiment depicted in FIG. 1, the management system 104 can include at least one controller 120, a database 122, the computational member 124, and/or one or more input/output (I/O) devices 126. According to certain embodiments, the management system 104 can be configured to provide an operator direct control of the robot 106, as well as to provide at least certain programming or other information to the robot station 102 and/or for the operation of the robot 106. Moreover, the management system 104 can be structured to receive commands or other input information from an operator of the robot station 102 or of the management system 104, including, for example, via commands generated via operation or selective engagement of/with an input/output device 126. Such commands via use of the input/output device 126 can include, but is not limited to, commands provided through the engagement or use of a microphone, keyboard, touch screen, joystick, stylus-type device, and/or a sensing device that can be operated, manipulated, and/or moved by the operator, among other input/output devices. Further, according to certain embodiments, the input/output device 126 can include one or more monitors and/or displays that can provide information to the operator, including, for, example, information relating to commands or instructions provided by the operator of the management system 104, received/transmitted from/to the supplemental database system(s) 105 and/or the robot station 102, and/or notifications generated while the robot 102 is running (or attempting to run) a program or process. For example, according to certain embodiments, the input/output device 126 can display images, whether actual or virtual, as obtained, for example, via use of at least the vision device 114a of the vision system 114.

According to certain embodiments, the management system 104 can include any type of computing device having a controller 120, such as, for example, a laptop, desktop computer, personal computer, programmable logic controller (PLC), or a mobile electronic device, among other computing devices, that includes a memory and a processor sufficient in size and operation to store and manipulate a database 122 and one or more applications for at least communicating with the robot station 102 via the communication network or link 118. In certain embodiments, the management system 104 can include a connecting device that may communicate with the communication network or link 118 and/or robot station 102 via an Ethernet WAN/LAN connection, among other types of connections. In certain other embodiments, the management system 104 can include a web server, or web portal, and can use the communication network or link 118 to communicate with the robot station 102 and/or the supplemental database system(s) 105 via the internet.

The management system 104 can be located at a variety of locations relative to the robot station 102. For example, the management system 104 can be in the same area as the robot station 102, the same room, a neighboring room, same building, same plant location, or, alternatively, at a remote location, relative to the robot station 102. Similarly, the supplemental database system(s) 105, if any, can also be located at a variety of locations relative to the robot station 102 and/or relative to the management system 104. Thus, the communication network or link 118 can be structured, at least in part, based on the physical distances, if any, between the locations of the robot station 102, management system 104, and/or supplemental database system(s) 105. According to the illustrated embodiment, the communication network or link 118 comprises one or more communication links 118 (Comm link_{1-N} in FIG. 1). Additionally, the system 100 can be operated to maintain a relatively reliable real-time communication link, via use of the communication network or link 118, between the robot station 102, management system 104, and/or supplemental database system(s) 105. Thus, according to certain embodiments, the system 100 can change parameters of the communication link 118, including, for example, the selection of the utilized communication links 118, based on the currently available data rate and/or transmission time of the communication links 118.

The communication network or link 118 can be structured in a variety of different manners. For example, the communication network or link 118 between the robot station 102, management system 104, and/or supplemental database system(s) 105 can be realized through the use of one or more of a variety of different types of communication technologies, including, but not limited to, via the use of fiber-optic, radio, cable, or wireless based technologies on similar or different types and layers of data protocols. For example, according to certain embodiments, the communication network or link 118 can utilize an Ethernet installation(s) with wireless local area network (WLAN), local area network (LAN), cellular data network, Bluetooth, ZigBee, point-to-point radio systems, laser-optical systems, and/or satellite communication links, among other wireless industrial links or communication protocols.

The database 122 of the management system 104 and/or one or more databases 128 of the supplemental database system(s) 105 can include a variety of information that may be used in the identification of elements within the robot station 102 in which the robot 106 is operating. For example, as discussed below in more detail, one or more of the databases 122, 128 can include or store information that is used in the detection, interpretation, and/or deciphering of images or other information detected by a vision system 114, such as, for example, an first or artificial calibration feature(s) and/or second or nature calibration feature(s). Additionally, or alternatively, such databases 122, 128 can include information pertaining to the one or more sensors 132, including, for example, information pertaining to forces, or a range of forces, that are to be expected to be detected by via use of the one or more force sensors 134 at one or more different locations in the robot station 102 and/or along the vehicle 136 at least as work is performed by the robot 106. Additionally, information in the databases 122, 128 can also include information used to at least initially calibrate the one or more sensors 132, including, for example, first calibration parameters associated with first calibration features and second calibration parameters that are associated with second calibration features.

The database 122 of the management system 104 and/or one or more databases 128 of the supplemental database system(s) 105 can also include information that can assist in discerning other features within the robot station 102. For example, images that are captured by the one or more vision devices 114a of the vision system 114 can be used in identifying, via use of information from the database 122, FTA components within the robot station 102, including FTA components that are within a picking bin, among other components, that may be used by the robot 106 in performing FTA.

FIG. 2 illustrates a schematic representation of an exemplary robot station 102 through which vehicles 136 are moved by an automated or automatic guided vehicle (AGV) 138, and which includes a robot 106 that is mounted to a robot base 142 that is moveable along, or by, a track 130 or mobile platform such as AGV. While for at least purposes of illustration, the exemplary robot station 102 depicted in FIG. 2 is shown as having, or being in proximity to, a vehicle 136 and associated AGV 138, the robot station 102 can have a variety of other arrangements and elements, and can be used in a variety of other manufacturing, assembly, and/or automation processes. Further, while the depicted robot station 102 can be associated with an initial set-up of a robot 106, the station 102 can also be associated with use of the robot 106 in an assembly and/or production process.

Additionally, while the example depicted in Figure illustrates a single robot station 102, according to other embodiments, the robot station 102 can include a plurality of robot stations 102, each station 102 having one or more robots 106. The illustrated robot station 102 can also include, or by operated in connection with, one or more AGV 138, supply lines or conveyors, induction conveyors, and/or one or more sorter conveyors. According to the illustrated embodiment, the AGV 138 can be positioned and operated relative to the one or more robot stations 102 so as to transport, for example, vehicles 136 that can receive, or otherwise be assembled with or to include, one or more components of the vehicle(s) 136, including, for example, a door assembly, a cockpit assembly, and a seat assembly, among other types of assemblies and components. Similarly, according to the illustrated embodiment, the track 130 can be positioned and operated relative to the one or more robots 106 so as to facilitate assembly by the robot(s) 106 of components to the vehicle(s) 136 that is/are being moved via the AGV 138. Moreover, the track 130 or mobile platform such as AGV, robot base 142, and/or robot can be operated such that the robot 106 is moved in a manner that at least generally follows of the movement of the AGV 138, and thus the movement of the vehicle(s) 136 that are on the AGV 138. Further, as previously mentioned, such movement of the robot 106 can also include movement that is guided, at least in part, by information provided by the one or more force sensor(s) 134.

FIG. 5 illustrates an exemplary process 200 for calibrating one or more sensors 132 of a sensor fusion guided robot 106. The operations illustrated for all of the processes in the present application are understood to be examples only, and operations may be combined or divided, and added or removed, as well as re-ordered in whole or in part, unless explicitly stated to the contrary. Further, while the process 200 discussed herein can be utilized at a variety of different time periods during the lifetime or and/or stages of operation of the robot 106, and/or in a variety of different settings, according to certain embodiments the process 200 can be used at least during the initial set-up and/or optimization phases of a sensor fusion guided robot 106, and moreover, prior to the robot 106 being utilized in an assembly or manufacturing line, operation, or application.

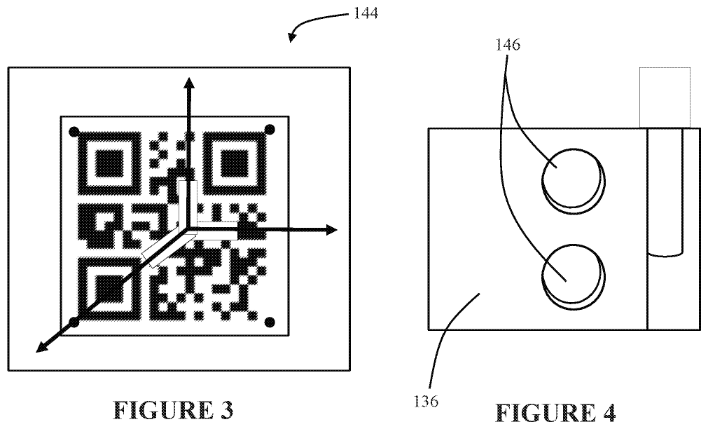

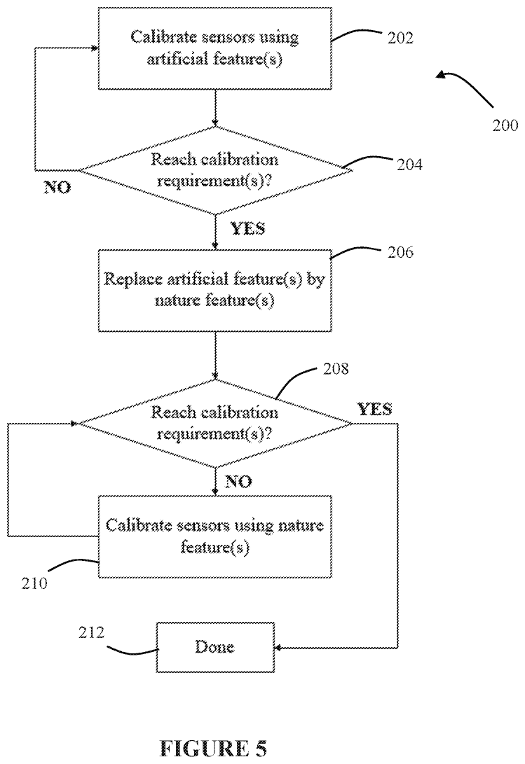

As shown in FIG. 5, at step 202, the sensors 132 can at least initially be calibrated using one or more first calibration features 144 (FIGS. 2 and 3). The first calibration features 144 can have a configuration, or be at a location, that may be less susceptible to noise, and moreover less susceptible to high noise, and error than other types of second calibration features 146 (FIGS. 2 and 4) that, as discussed below, can subsequently be utilized in refining the calibration of the sensors 132. Thus, according to certain embodiments, the first calibration features 144, also referred to herein as artificial features, can be features that are configured and/or at a location in the robot station 102 that may be less susceptible to noise, including, for example, noise associated with lighting, movement irregularities, vibrations, and balancing issues, than other, second calibration features 146. Thus according to certain embodiments, while the second calibration feature(s) 146 may relate to feature(s) that the sensors 132 will eventually track, engage, or otherwise utilize in the assembly operation that the robot 106 is being programmed or trained to perform, the first calibration features 144 can be features that are utilized to at least initially calibrate the sensors 132 to satisfy a relatively narrow range of first calibration parameters. As discussed below, the calibration of the sensors 132 can subsequently be further refined such that the calibrated sensors 132 satisfy an even narrower range of second calibration parameters.

Thus, for example, according to certain embodiments, such first calibration features 144 can include, but are not limited to, items that are configured and/or position primarily for use in calibrating the sensors 132. For example, with respect to at least calibration of the vision system 114, according to certain embodiments, the first calibration feature 144 can be a three-dimensional quick response (QR) code, as shown, for example, in FIG. 3. However, a variety of other types of images or visual indicators can be utilized for the first calibration feature 144 in connection with at least the initial calibration of the vision system 114, including, but not limited to, two dimensional QR codes. Alternatively, or additionally, the first calibration feature 144 can be a portion of the vehicle 136 or workpiece, or related component, which is at a location that is generally less susceptible to noise than other portions of the vehicle 136 or workpiece.

Further, calibration using a first calibration feature 144 can involve comparing sensed information with known information. For example, with respect to force sensors 134, when the robot 106 is at a particular location(s), or moving in a particular direction(s), the force(s) detected by the force sensor(s) 134 at that known location(s) or direction(s) can be compared to a known force measurement(s) for that location(s) or direction(s). Similar to the first calibration feature 144 used for calibrating the vision system 114, the component and/or location used for the calibration of the force sensor(s) 134 of the robot 106 can be a location that is, or is not, on the vehicle 136 or workpiece, that is generally less susceptible that other locations, including, for example, a location that is less susceptible to movement irregularities, vibrations, and balancing issues. Further, the same first calibration feature 144 can be used to calibrate different types of sensors 132, including, for example, the same first calibration feature 144 being used for calibrating both the vision system 114 and the force sensor(s) 134. For example, according to certain embodiments, the first calibration feature 144 can include an image associated with calibration of the vision system 114 and be at a location that is used in connection with calibration of the force sensor 134.

Accordingly, the first calibration feature 144 can be at a variety of locations about the robot station 102. For example, as shown in FIG. 5, according to certain embodiments, a first calibration feature 144 can be positioned on the AGV 138, including, for example, on a portion of the AGV 138 that is beneath, and which is moving along with, the vehicle 136. Additionally, or alternatively, according to certain embodiments, the first calibration feature 144 can be located on a portion of the vehicle 136 that is not directly involved in the assembly operation for which the robot 106 is being set up, and/or optimized to perform. For example, according to certain embodiments, while the robot 106 may be in the process of being programmed for eventual use in a FTA assembly operation in which the robot 106 may need to locate and align holes around a door opening or door post in a vehicle 136, the first calibration feature 144 may be at, or mounted to, some other portion of the vehicle 136, such as, for example a portion of a rear roof post.

At step 204, a determination can be made, such as, for example, by the controller 112, as to whether the calibration of the sensors 132 via use of the first calibration feature(s) 144 has satisfied first calibration parameters or criteria associated with the first calibration features 144. Such parameters, which can, for example, be predetermined and stored in a memory that is accessible to, or in electrical communication with, the controller 112, can be evaluated based on information provided by each sensor or sensor type, and/or can be based on an evaluation(s) of the movement of the robot 106 as guided by sensor fusion that is based on the current degree of calibration of the sensors 132. Further, the parameters associated with the first calibration parameters may, according to certain embodiments, be broader than parameters used with further or additional calibration of the sensors 132 when using other, second calibration features 146, as discussed below.

Thus, for example, according to certain illustrated embodiments, a determination as to whether first calibration parameters have been satisfied can be based, at least in part, on a value(s) of a force sensed by the force sensor 134 being within a predetermined parameter range or satisfying a predetermined parameter threshold, the degree of errors, if any, in the movement of the robot 106 when using the vision system 114, and/or the accuracy in the movement of the robot 106 when guided using information provided by a plurality of the sensors 132, such as, for example, when using combined or integrated information from at least the force sensors 134 and the vision system 114, among other sensors.

If, at step 204, it is determined, such as, for example, by the controller 112, that the first calibration parameters are not satisfied by the one or more of the sensors 132, or that the movement of the robot 106, as guided by sensor fusion, does not have a requisite degree of accuracy, then the process 200 can continue with calibrating the sensors 132 at step 202 via use of the first calibration features 144.

However, if at step 204 it is determined that the first calibration parameters are satisfied, then at step 206, for purposes of calibration, the first calibration features 144 can be replaced with the second calibration features 146, also referred to as nature calibration features. Compared to first calibration features 144, the second calibration features 146 can be features on or in the vehicle 136 that are directly involved or utilized in the assembly process that is to be performed using the robot 106. For example, according to certain embodiments, the second calibration features 146 can be one or more holes (FIGS. 2 and 4) that are to receive insertion of a component or a portion of a component, such as, for example, a mounting post, and/or a mechanical fastener, such as, for example, bolt, pin, screw, while the robot 106 is performing an assembly process, including, for example, an FTA operation.

As the second calibration features 146 can be portions of the vehicle 136 that are directly involved in at least some aspect of the assembly process that will be performed by the robot 106, there may not be the same degree of freedom or flexibility in choosing the second calibration features 146 as there can be in selecting the first calibration features 144. Thus, unlike the first calibration features, calibration of the second calibration features 146 can involve portions of the vehicle 136, or related components, that have a size, configuration, positon, number, and/or movement, as well as any combination thereof, among other factors, that can create a higher degree of difficulties relating to calibrating the sensors 132. Such difficulties can include increased challenges presented by noise associated with lighting, vibrations, and movement, among other noise and forms of errors. For example, a second calibration feature 146 can be one or more holes that are sized, positioned, and/or oriented in a manner that creates potential issues with the vision system 114 capturing a clear image of the second calibration feature 146. Moreover, in such situations, the second calibration feature 146 may receive too much, or too little, light, or vibrate in a manner that causes pixilation issues in the image(s) captured by the vision system 114. Such pixilation can be create difficulties in the robot 102 accurately detecting, or detecting with a desired degree of precision, the location and/or boundaries of the second calibration feature 146, thus further complicating the calibration process using the second calibration feature 146. However, the process 200 discussed herein can reduce or minimize such complexity and time associated with calibration using the second calibration features 146, as the sensors 132 are already pre-calibrated due to the sensors 132 previously being calibrated to satisfy at least the first calibration criteria. Thus, according to the illustrated embodiment, calibration based on the second calibration features 146 can involve the calibration of the already well-calibrated sensors 132 being further refined or narrowed, if necessary, to satisfy the even narrower parameters of second calibration parameters that are associated with the second calibration features 146. Such a process 200 not only can decrease the complexity and time associated with calibrating the sensors 132 to satisfy second calibration parameters associated with the second calibration features 146, but can also lead to a more accurate calibration than if calibration were based directly on the second calibration features 146 and without the benefit of the first calibration features 144. Further, such improved accuracy in the calibration of the sensors 132 can lead to a more reliable and stable operation of the robot 106, including the sensor fusion guided movement of the robot 106.

At step 208, the process 200 can determine if the calibration attained in connection with satisfying the first calibration parameters at step 204 also satisfies the second calibration parameters, which, as previously mentioned, are narrower than the corresponding parameters of the first calibration criteria from step 206. If the calibration of the sensors 132 attained at steps 202 and 204 satisfy the second calibration parameters, then the calibration process 200 can conclude at step 212. If, however, further refinement of calibration is needed, then at step 210, the sensors 132 can again undergo calibration, with the calibration process now utilizing the second calibration features 146. Such calibration can continue until a determination is made at step 208, such as, for example, by the controller 112, that the sensors 132 have been calibrated in a manner that satisfies the second calibration parameters. Again, upon a determination that the sensors 132 have been calibrated in a manner that satisfies the second calibration parameters, then the calibration process 200 can proceed to step 212, wherein the calibration process 200 is concluded.

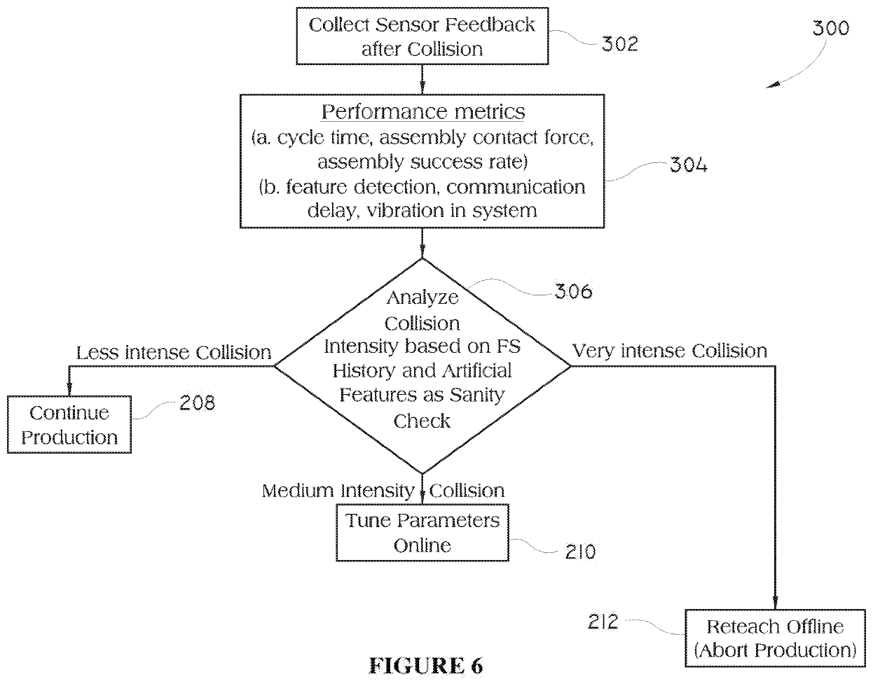

FIG. 6 illustrates an exemplary process 300 for assessing the severity of an impact event between the robot 106 and vehicle 136. As will be appreciated, in the embodiments contemplated herein the robot 106 includes an end effector useful to grasp an automotive workpiece which can be assembled onto/within the vehicle assembly 136. The automotive workpiece can take the form of a door assembly, cockpit assembly, seat assembly, etc. As will be further appreciated, the robot 106 can be maneuvered to position the automotive workpiece into contact with one or more portions of the vehicle 136. For example, door hinges in the form of feature 146 on the vehicle 136 can be used to engage a door that is grasped by the robot 106 as the door is positioned into engagement with the door hinges 146. In this context, the door hinges are part of the automotive assembly, albeit already attached to the vehicle 136. As the robot 106 is moved along the track 130 or mobile platform such as AGV vibrations and other perturbations can be present which makes precise tracking of the robot a more difficult task.

As shown in FIG. 6, at step 302, the sensors can be used to collect information related to a collision between the workpiece being maneuvered by the robot 106, and one or more portions of the vehicle 136 during the assembly process of the workpiece with the vehicle 136. Step 302 can include the collection of information directly from measurement sensors, or it can include a collection of information that has been computed from measurement sensors. The measurement sensors can include information from an image sensor, such as those associated with vision system 114 and/or 114a, as well as information from a force sensor, such as those associated with force sensor 134. The controller 112 can use both image feedback from image sensor as well as force feedback from force sensor to regulate motion of the robot 106.

As will be appreciated, the force sensor 134 can take a variety of forms capable of directly measuring force and/or estimating force from other collected data. For example, sensors that measure electrical current associated with an electrical motor can be used to determine the force imparted to the electrical motor. The robot 106 can have a variety of electrical motors structured to provide motive force to the robot 106. A number of sensors can be used to monitor electrical current associated with operation of the electrical motor. The sensed current can then be used to estimate force imparted to the motor.

The data collected with sensors at step 302 can be collected at a variety of data acquisition rates and can be collected over any period of time. For example, data can be continuously collected and a windowing operation can be performed around a collision event. Such windowing operation can be used to collect data prior to the collision and after the collision event to ensure that the entire collision event is captured. The force data may include some noise, and may include impact characteristics in the form of multiple force and torque peaks which can be caused by momentum, flexure, rebounding, and other physical reactions caused by the collision. In some operations the controller 112 can be preprogrammed to include a time window around an anticipated impact event b. In other alternative and/or additional forms the data collected with sensors at step 302 can be reduced to single number. In one example such single number may represent the peak force associated with a collision event. Whether the data is a time history or calculated from time history data (e.g. a maximum peak force, frequency domain measure such as a power spectral density, etc), such data is used further in the steps depicted in FIG. 6 to determine the severity of the collision and take appropriate action.

In some forms of the device described herein, step 304 can be included to assess performance metrics of the system which includes the robot 106 and the vehicle 136. The performance metrics may not be needed in every embodiment which includes the steps depicted in FIG. 6. The performance metrics are listed in step 304 and can be assessed independent of one another, or can be combined to form a blended performance metric based upon two or more of the metrics described in step 304.

At step 306, the controller 112 is structured to analyze the intensity of the collision measured or estimated from the sensed information collected at step 302. A controller 112 is structured to assess the intensity of the collision based on the force sensor information provided from the force sensor. Additionally, in some forms the controller 112 can use the artificial feature 144 or the natural feature 146 to perform a sanity check. As will be appreciated, an artificial feature can be associated with either or both of the automotive assembly and the automotive workpiece. Additionally and/or alternatively, a natural feature can be associated with either or both the automotive assembly and the automotive workpiece. Such a sanity check can be used to determine if the force information collected at step 302 can be relied upon. The controller 112 can be structured to assess the intensity of the force sensor information in a tiered manner. For example, a low intensity collision as assessed by the controller 112 will permit the robot 106 to continue its operations in maneuvering workpieces into contact with the vehicle 136 or with a subsequent vehicle. Higher intensity collisions can result in updates to the controller 112 with continued operation of the robot 106, and in some forms very high intensity collisions can result in updates to the controller 112 along with an abort procedure in which the robot 106 ceases to maneuver a workpiece to the vehicle 136.

The controller 112 at step 306 can compare information from the force sensor with a reference value to determine the category in which the collision should be classified. In the illustrated form of FIG. 6 collisions can be categorized into one of three categories, but other implementations can consider fewer or greater numbers of categories. Reference will the made to the three regions depicted in FIG. 6, but no limitation is hereby intended that embodiments must be limited to only three regions. The reference value that is used with the controller 112 can take a variety of forms. In some forms, the reference value can take the form of two separate values which are used to separate regions associated with a minor collision, medium collision, and the more intense high collision region. In one embodiment, the reference value is a time history of force data associated with a particular motion of the robot 106, such that if the sensor feedback information collected during operation of the robot 106 exceeds a threshold associated with the reference value, such excursion can be used to characterize the collision event as a minor collision, medium collision, or high collision.

Also contemplated in an embodiment herein is a comparison of one or more performance metrics, or a blended version of the performance metric, prior to determination of the collision intensity. In addition, as stated above, the artificial feature 144 and/or the natural feature 146 can also be used to augment the determination of whether a collision satisfies the criteria of any of the collision categories.

Depicted in FIG. 6 are three separate branches which dictate the consequence of the collision and its impact on operation of the robot 106. If the collision was assessed as a minor collision, step 208 permits continued operation of the robot 106. Step 210 will result in one or more parameters associated with the controller 112 to be tuned. Such tuning can include recalibration of the image sensor using either the artificial feature 144 or the natural feature 146. Such recalibration may be required if changes are present in the environment of the robot 106, such as a different lighting condition currently experienced by the robot, occlusions now present which impact the quality of the image from the image sensor, etc. It is contemplated that such re-tuning can be accomplished with minimal or no impact to continued manufacturing operations associated with the robot 106 as it engages workpieces with the vehicle 136.

As used herein, discussions related to forces associated with contact between the workpiece and the vehicle 136 associated with relative movement of the robot end effector includes both forces and torques as it will be appreciated that torque is a product of force. The use of the term “force” alone in the description herein is used herein to simplify the discussion but in no way is it intended to limit the application of the instant disclosure to only forces. For example, if a collision is better assessed using torques, associated reference values for torques, and accompanying sensors/estimators for determining impacted torque can be used. Any use of “force” is intended to encompass also torques as they can be synonymous with one another in this context.

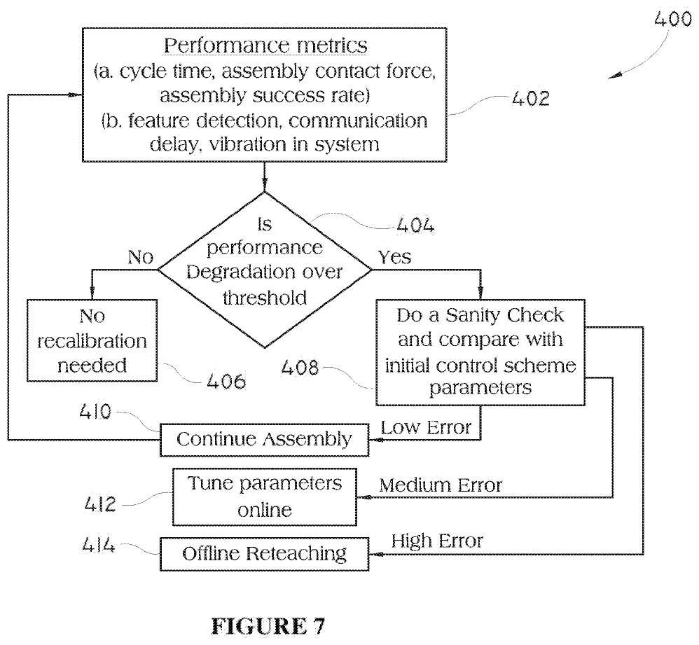

FIG. 7 illustrates an exemplary process 400 for determining whether performance of embodiments of the system depicted in the discussion above is adequate, and if not then what actions can be taken to address the lack of performance. The techniques described related to embodiments that incorporate FIG. 7 can be used before operation of the robot 106, such as before a manufacturing shift begins, but can also be used during operation of the robot 106 while it is in the midst of a manufacturing shift. For example, in between fastening workpieces to the vehicle 136 the robot 106 can be commanded to check its performance using the steps described in FIG. 7. The robot 106 can also be commanded to take a short duration break to check performance. In short, the steps described in FIG. 7 can be used at any variety of times.

As shown in FIG. 7, at step 402, a blended measure of performance can be calculated which can be a combination of a variety of measures. Shown in block 402 are a few nonlimiting examples of performance measures that relate to manufacturing and internal components, but other measures are also contemplated herein. Measures such as cycle time can any type of time, such as the cycle it takes to progress the vehicle 136 through various workstations, or the cycle that it takes the robot 106 to grasp a workpiece, move it to the vehicle 136, install the workpiece, and return to a starting position, are contemplated. Other cycle times are also contemplated. Other measures include the contact force associated with assembling the workpiece to the vehicle 136, as well as the success rate of the assembly. Still further measures include the ability of the robot 106 to detect the artificial and/or natural features, any communication delay in the system (such as, but not limited to, delays that may be caused by extended computational durations due to changing environmental conditions such as lighting), as well as vibration that may be present. Any two or more of these measures, as well as any other relevant measures, can be blended together to form an overall performance metric that can be compared during operation, or before operation, of the robot 106. The two or measures can be blended using any type of formulation, such as straight addition, weighted addition, ratio, etc.

At step 404, the blended performance metric can be compared against a performance threshold to determine if overall system performance is being maintained or if there is any degradation in performance. If the blended performance metric remains below an acceptable degradation threshold, then no recalibration is needed as in step 406. If, however, the blended performance metric exceeds the acceptable degradation threshold, then the process 400 proceeds to step 408.

At step 408, the controller 112 is configured to perform a sanity check on one or more components of the robot 106 prior to determining a next step. Step 408 can be dubbed a ‘sanity check’ to determine whether a sensor fusion process associated with operation of the robot 106 is operating properly. In the controller 112 is constructed to determine a sensor fusion output based upon 18 number of variables. In one form, the sensor fusion output can be constructed from a combination of information related to the force sensor 134 and the vision sensor 114. The vision sensor 114 can be used to capture an image of the artificial feature 144 and/or the natural feature 146, which image can then be used in the calculation of a sensor fusion parameter along with any other suitable value (force sensor, etc).

The sensor fusion can represent any type of combination of any number of variables. For example, individual sensed or calculated values can be added together, they can be added together and divided by a constant, each value can be weighted and then added to one another, etc. In still other forms the values can be processed such as through filtering before being combined with each other. In one non-limiting form, the sensor fusion can represent a control signal generated by a subset of the controller 112 that regulates based upon information from the force sensor, which is then combined with a control signal generated by a different subset of the controller 112 that regulates based upon information from the image sensor. Such control regulation schemes can be independent from one another, and can take any variety of forms. For example, the force feedback regulation can use a traditional PID controller, while the image feedback regulation can use a different type of controller. Each control signal generated from the different control regulations schemes can be combined together into a control regulation parameter which can represent a sensor fusion output. This method of determining a sensor fusion parameter through control regulation calculations, however, is just one of a variety of signals that can represent a sensor fusion.

At step 408, the sensor fusion parameter is compared against a sensor fusion reference to determine a control action which can be initiated by the controller 112. The sensor fusion reference can be predetermined based on any variety of approaches including experimental determination as well as formulaic determination. In one form the sensor fusion reference used can represent the best case sensor fusion when looking at the artificial feature with the image sensor. For example, the best case sensor fusion can represent a theoretical value derived formulaically, or can represent a sensor fusion using the best lighting and environmental conditions to ensure optimal robot performance.

The comparison at step 408 can result in categorization of sensor fusion error and two at least two separate categories. As illustrated in FIG. 7, three separate categories of sensor fusion error are represented, the other embodiments can include fewer or greater numbers of categories. In one form the sensor fusion parameter can be compared against a sensor fusion reference by subtracting the two values. Other techniques of comparing the sensor fusion parameter with the sensor fusion reference are also contemplated herein. Whichever technique is used to determine the comparison between the sensor fusion parameter and the sensor fusion reference, step 408 is used to evaluate the comparison against at least one sensor fusion difference threshold.

At step 410, if the comparison between the sensor fusion parameter and the sensor fusion reference fails to exceed a first sensor fusion difference threshold, then the controller 112 commands the robot 106 to continue with its assembly. At this point, process 400 returns to assessing the performance metric at an appropriate time. Such returned to evaluation of the performance metrics at step 402 can occur immediately, or can be scheduled at a later time, or can occur at periodic frequencies. The performance metrics can also be determined at other times including been randomly requested by an operator. In short, the procedure from step 410 to step 402 can occur at any time.

At step 412, if the comparison between the sensor fusion parameter and the sensor fusion reference exceeds the first sensor fusion difference threshold, then the controller 112 commands the robot 106 to tune certain parameters. Such tuning of parameters can include using the vision sensor 114 to image the artificial feature and/or the natural feature described above. Such reimaging of the artificial feature and/or the natural feature might be necessary if certain environmental changes have occurred which have changed performance of the image sensor 114. For example, if the vision system or calibrated using either the artificial feature and/or the natural feature in a good lighting condition, but subsequent changes near the robot 106 have resulted in poor lighting conditions, then recalibrating the vision sensor can be beneficial to improve performance of the robot 106. Different vibrations in the system relative to an original vibration level present when the robot was taught may also cause degradation in the vision sensor, which re-tuning can also aid. Still other reasons for degradation in performance is a change in robot location, or a change in its task, or a change in the workpiece that the robot is manipulating. Any and all of these reasons can contribute to a degradation in performance of the robot 106 which may manifest themselves at step 402 and/or at step 408. As will be appreciated, other sensors can also be used during step 412 to recalibrate any variety of parameters associated with the controller 112 and operation of the robot 106, which sensors may also be impacted by any of the aforementioned reasons related to why performance of the robot 106 may be degraded.

At step 414, if the comparison between the sensor fusion parameter and the sensor fusion reference exceeds a second sensor fusion difference threshold, then the controller 112 can take the robot offline for reteaching. Such reteaching can involve removing the robot from the assembly line to be re-taught, or re-teaching the robot 106 in place while the production line is paused and/or stopped.

One aspect of the present application includes an apparatus comprising an automotive manufacturing robot system configured to assess a collision between a robot and an automotive assembly, the robot including an end effector configured to be coupled with an automotive workpiece and structured to be movable relative to the automotive assembly, a force sensor to detect a force imparted by contact between the automotive workpiece and the automotive assembly through movement of the end effector, and an image sensor structured to capture an image of at least one of the automotive workpiece and the automotive assembly, the automotive manufacturing robot system also including a controller configured to generate commands useful to manipulate the end effector and in data communication with the force sensor to receive force feedback information from the force sensor and to receive image information from the image sensor, the controller structured to: regulate position of the end effector using the force feedback information and the image information; collect engagement force feedback information associated with an engagement event caused by motion of the end effector relative to the automotive assembly; compare engagement force feedback information with a force reference to generate a force event comparison; classify the force event comparison into one of at least two tiers; generate a signal to continue production if the force event comparison is classified in a first of the at least two tiers; and generate a signal to interrupt production if the force event comparison is classified in a second of the at least two tiers.

A feature of the present application includes wherein the force feedback sensor is structured to provide an estimate of a force by use of an electric motor current associated with an electrical motor of the robot.

Another feature of the present application includes wherein the engagement event includes a period of time before and after physical contact between at least a portion of the robot with the automotive workpiece, and wherein physical contact is determined by a time period which bounds a peak current event.

Still another feature of the present application includes wherein the end effector is structured to grasp the automotive workpiece such that the automotive workpiece is brought into contact with the automotive workpiece during the engagement event by movement of the end effector, and wherein the image sensor is structured to capture an image of a feature during a process during which the automotive workpiece is brought into contact with the vehicle assembly, the feature including one of a natural feature and an artificial feature.

Yet another feature of the present application includes wherein the controller is further structured to collect engagement image information associated with the engagement event, wherein the robot is situated upon a movable platform, wherein the automotive assembly is situated upon a moveable platform, and wherein the movable platform having the robot moves in concert with the moveable platform having the automotive assembly.

Still yet another feature of the present application includes wherein the first of the at least two tiers is a first intensity collision, wherein the second of the at least two tiers is a second intensity collision higher in intensity than the first intensity collision, and wherein the controller is configured to be placed into a reteach mode when the force event comparison is classified in the second of the at least two tiers.

Yet still another feature of the present application includes wherein the controller is further structured to generate a signal to continue production and to tune at least one parameter of the controller when the force event comparison is classified in a third of the at least two tiers, the third of the at least two tiers representing a third intensity collision higher than the first intensity collision but lower than the second intensity collision.

A further feature of the present application includes wherein the controller is further structured to tune the at least one parameter through recalibration of the image sensor with a calibration feature.

A still further feature of the present application includes wherein the force reference is a time history based limit, wherein the controller is structured to compare a time history of force feedback information during the engagement event against the time history based limit.

Yet another aspect of the present application includes an apparatus comprising an automotive manufacturing robot system configured to regulate a robot as it moves relative to an automotive assembly, the robot including an end effector structured to couple with an automotive workpiece which can be moved by action of the robot into contact with the automotive assembly, a force sensor to detect a force imparted by contact between the automotive workpiece and the automotive assembly by relative movement of the end effector, and an image sensor structured to capture an image at least one of the automotive assembly and automotive workpiece, the automotive manufacturing robot system also including a controller configured to generate commands useful to manipulate the end effector and in data communication with the force sensor to receive force feedback information from the force sensor and to receive image information from the image sensor, the controller structured to: calculate a blended performance metric based upon at least two performance measures; compare the blended performance metric against a performance threshold; compute a sensor fusion output based on a combination of information from at least two sensors; and generate a sensor fusion difference between the sensor fusion output and a sensor fusion reference to determine a control action initiated by the controller.

A feature of the present application includes wherein the at least two sensors are the image sensor and the force feedback sensor.

Another feature of the present application includes wherein if the sensor fusion difference fails to exceed a sensor fusion difference threshold, continue operation with the robot, and wherein if the sensor fusion difference exceeds the sensor fusion difference threshold by a second amount greater than the first amount, continue operation with the robot and change at least one parameter associated with the controller.

Still another feature of the present application includes wherein if the sensor fusion difference exceeds the sensor fusion difference threshold by a second amount greater than the first amount, continue operation with the robot and tune at least one parameter associated with the controller.

Yet another feature of the present application includes wherein if the sensor fusion difference exceeds the sensor fusion difference threshold by a second amount greater than the first amount, continue operation with the robot and reteach the robot to change at least one parameter associated with the controller.

Still yet another feature of the present application includes wherein the sensor fusion difference threshold is a first sensor fusion difference threshold, wherein the controller includes a second sensor fusion difference threshold, and wherein if the sensor fusion difference exceeds the second sensor fusion difference threshold, remove the robot from operation and configure the controller to be in a reteaching mode.

Yet still another feature of the present application includes wherein the controller is further structured to check whether the control scheme selection and sensor parameters satisfy a cost function.

A further feature of the present application includes wherein the controller is further structured to provide compensation for at least one of vibration and noise.

A yet further feature of the present application includes wherein the controller is further structured to check whether the vibration and noise compensation meets operational criteria.

Another feature of the present application includes wherein the controller is structured to compare information from the image sensor with a reference to assess whether the vibration and noise compensation meets operational criteria.

Still yet another feature of the present application includes wherein the at least two sensors are the image sensor and the force feedback sensor; wherein if the sensor fusion difference fails to exceed a sensor fusion difference threshold, continue operation with the robot; wherein if the sensor fusion difference exceeds the sensor fusion difference threshold by a second amount greater than the first amount, continue operation with the robot and change at least one parameter associated with the controller; wherein the sensor fusion difference threshold is a first sensor fusion difference threshold; wherein the controller includes a second sensor fusion difference threshold; and wherein if the sensor fusion difference exceeds the second sensor fusion difference threshold, remove the robot from operation and configure the controller to be in a reteaching mode.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. An apparatus comprising:
an automotive manufacturing robot system configured to assess a collision between a robot and an automotive assembly, the robot including an end effector configured to be coupled with an automotive workpiece and structured to be movable relative to the automotive assembly, a force sensor to detect a force imparted by contact between the automotive workpiece and the automotive assembly through movement of the end effector, and an image sensor structured to capture an image of at least one of the automotive workpiece and the automotive assembly, the automotive manufacturing robot system also including a controller configured to generate commands useful to manipulate the end effector and in data communication with the force sensor to receive force feedback information from the force sensor and to receive image information from the image sensor, the controller structured to:
regulate position of the end effector using the force feedback information and the image information;
collect engagement force feedback information associated with an engagement event caused by motion of the end effector relative to the automotive assembly;
compare engagement force feedback information with a force reference to generate a force event comparison;
classify the force event comparison into one of at least two tiers;
generate a signal to continue production if the force event comparison is classified in a first of the at least two tiers; and
generate a signal to interrupt production if the force event comparison is classified in a second of the at least two tiers.

2. The apparatus of claim 1, wherein the force feedback sensor is structured to provide an estimate of a force by use of an electric motor current associated with an electrical motor of the robot.

3. The apparatus of claim 2, wherein the engagement event includes a period of time before and after physical contact between at least a portion of the robot with the automotive workpiece, and wherein physical contact is determined by a time period which bounds a peak current event.

4. The apparatus of claim 1, wherein the end effector is structured to grasp the automotive workpiece such that the automotive workpiece is brought into contact with the automotive workpiece during the engagement event by movement of the end effector, and wherein the image sensor is structured to capture an image of a feature during a process during which the automotive workpiece is brought into contact with the vehicle assembly, the feature including one of a natural feature and an artificial feature.

5. The apparatus of claim 4, wherein the controller is further structured to collect engagement image information associated with the engagement event, wherein the robot is situated upon a movable platform, wherein the automotive assembly is situated upon a moveable platform, and wherein the movable platform having the robot moves in concert with the moveable platform having the automotive assembly.

6. The apparatus of claim 5, wherein the first of the at least two tiers is a first intensity collision, wherein the second of the at least two tiers is a second intensity collision higher in intensity than the first intensity collision, and wherein the controller is configured to be placed into a reteach mode when the force event comparison is classified in the second of the at least two tiers.

7. The apparatus of claim 6, wherein the controller is further structured to generate a signal to continue production and to tune at least one parameter of the controller when the force event comparison is classified in a third of the at least two tiers, the third of the at least two tiers representing a third intensity collision higher than the first intensity collision but lower than the second intensity collision.

8. The apparatus of claim 7, wherein the controller is further structured to tune the at least one parameter through recalibration of the image sensor with a calibration feature.

9. The apparatus of claim 1, wherein the force reference is a time history based limit, wherein the controller is structured to compare a time history of force feedback information during the engagement event against the time history based limit.

10. An apparatus comprising:
an automotive manufacturing robot system configured to regulate a robot as it moves relative to an automotive assembly, the robot including an end effector structured to couple with an automotive workpiece which can be moved by action of the robot into contact with the automotive assembly, a force sensor to detect a force imparted by contact between the automotive workpiece and the automotive assembly by relative movement of the end effector, and an image sensor structured to capture an image at least one of the automotive assembly and automotive workpiece, the automotive manufacturing robot system also including a controller configured to generate commands useful to manipulate the end effector and in data communication with the force sensor to receive force feedback information from the force sensor and to receive image information from the image sensor, the controller structured to:
calculate a blended performance metric based upon at least two performance measures;
compare the blended performance metric against a performance threshold;
compute a sensor fusion output based on a combination of information from at least two sensors; and
generate a sensor fusion difference between the sensor fusion output and a sensor fusion reference to determine a control action initiated by the controller.

11. The apparatus of claim 10, wherein the at least two sensors are the image sensor and the force feedback sensor.

12. The apparatus of claim 10, wherein if the sensor fusion difference fails to exceed a sensor fusion difference threshold, continue operation with the robot, and wherein if the sensor fusion difference exceeds the sensor fusion difference threshold by a second amount greater than the first amount, continue operation with the robot and change at least one parameter associated with the controller.

13. The apparatus of claim 12, wherein if the sensor fusion difference exceeds the sensor fusion difference threshold by a second amount greater than the first amount, continue operation with the robot and tune at least one parameter associated with the controller.

14. The apparatus of claim 12, wherein if the sensor fusion difference exceeds the sensor fusion difference threshold by a second amount greater than the first amount, continue operation with the robot and reteach the robot to change at least one parameter associated with the controller.

15. The apparatus of claim 12, wherein the sensor fusion difference threshold is a first sensor fusion difference threshold, wherein the controller includes a second sensor fusion difference threshold, and wherein if the sensor fusion difference exceeds the second sensor fusion difference threshold, remove the robot from operation and configure the controller to be in a reteaching mode.

16. The apparatus of claim 10, wherein the controller is further structured to check whether the control scheme selection and sensor parameters satisfy a cost function.

17. The apparatus of claim 10, wherein the controller is further structured to provide compensation for at least one of vibration and noise.

18. The apparatus of claim 17, wherein the controller is further structured to check whether the vibration and noise compensation meets operational criteria.

19. The apparatus of claim 18, wherein the controller is structured to compare information from the image sensor with a reference to assess whether the vibration and noise compensation meets operational criteria.

20. The apparatus of claim 19, wherein the at least two sensors are the image sensor and the force feedback sensor; wherein if the sensor fusion difference fails to exceed a sensor fusion difference threshold, continue operation with the robot; wherein if the sensor fusion difference exceeds the sensor fusion difference threshold by a second amount greater than the first amount, continue operation with the robot and change at least one parameter associated with the controller; wherein the sensor fusion difference threshold is a first sensor fusion difference threshold; wherein the controller includes a second sensor fusion difference threshold; and wherein if the sensor fusion difference exceeds the second sensor fusion difference threshold, remove the robot from operation and configure the controller to be in a reteaching mode.
